(19) United States
(12) Patent Application Publication
(10) Pub. No.: US 2005/0114504 A1
(43) Pub. Date: May 26, 2005

(54) Carrier network capable of conducting remote diagnostics in a mobile handset

(76) Inventors: Sunil Marolia, Dana Point, CA (US); Vincent P. Soberano, Rancho Santa Margarita, CA (US)

Correspondence Address: MCANDREWS HELD & MALLOY, LTD, 500 WEST MADISON STREET, SUITE 3400, CHICAGO, IL, 60661, US

(21) Appl. No.: 10/888,841

(22) Filed: Jul. 9, 2004

Related U.S. Application Data
(60) Provisional application No. 60/485,881, filed on Jul. 9, 2003.

(51) Int. Cl. G06F 15/173

(52) U.S. Cl. 709/224

(57) ABSTRACT

Aspects of the present invention may be seen in a carrier network, employing the disclosed techniques and system. The network may be capable of conducting remote diagnostics of mobile handsets. The carrier network may have infrastructure to determine when known problems may occur in mobile handsets and determine how often they occur. In an embodiment of the present invention, when a customer reports in problems to a customer care representative, the carrier network may track such problems, install bug fixes or remotely diagnose the problem. The configuration parameters may be retrieved, analyzed and modified. When a customer reports errors or operational problems, the carrier may verify them or determine the nature and characteristics of such problems.

### RELATED APPLICATIONS

This patent application makes reference to, claims priority to and claims benefit from U.S. Provisional Patent Application Ser. No. 60/485,881, entitled “Carrier Network Capable of Conducting Remote Diagnostics in a Mobile Handset,” filed on Jul. 9, 2003.

The complete subject matter of the above-referenced U.S. Provisional Patent Application is hereby incorporated herein by reference, in its entirety. In addition, this application makes reference to U.S. patent application Ser. No. 10/754,313, entitled “Mobile Services Network for Update or Firmware/Software in Mobile Handsets,” filed Jan. 9, 2004, U.S. Provisional Patent Application Ser. No. 60/249,606, entitled “System and Method for Updating and Distributing Information,” filed Nov. 17, 2000, and International Patent Application Publication No. WO 02/41147 A1, entitled “Systems And Methods For Updating And Distributing Information,” publication date Mar. 23, 2002, the complete subject matter of each of which is hereby incorporated herein by reference, in its entirety.

### FEDERALLY SPONSORED RESEARCH OR DEVELOPMENT

[Not Applicable]

### [MICROFICHE/COPYRIGHT REFERENCE]

[Not Applicable]

### BACKGROUND OF THE INVENTION

Electronic devices, such as mobile phones and personal digital assistants (PDA's), often contain firmware and application software that are either provided by the manufacturers of the electronic devices, by telecommunication carriers, or by third parties. These firmware and application software often contain software bugs. New versions of the firmware and software are periodically released to fix the bugs or to introduce new features, or both.

Electronic devices may use update packages containing information necessary to update firmware/software in the electronic devices. Update packages may be downloaded into handsets such that their software or firmware could be updated.

Often, mobile handsets encounter operational problems such as, for example, missed calls, dropped calls, software that does not operate as expected, etc. Carrier networks may not have the capability to determine the pervasiveness of such problems, and may not have the infrastructure to determine when these problems occur or how often they occur. Unless a customer reports such problems to a customer care representative, the carrier often may not know about their existence. Even when the customer reports errors or operational problems, the carrier may be incapable of verifying them or determining the nature and characteristics of such problems.

Further limitations and disadvantages of conventional and traditional approaches will become apparent to one of ordinary skill in the art through comparison of such systems with the present invention.

### BRIEF SUMMARY OF THE INVENTION

Aspects of the present invention may be seen in a network that monitors activities of electronic devices in the network. The network may comprise at least one electronic device having firmware and at least one server communicatively coupled to the at least one electronic device. The at least one server may be capable of executing diagnostic procedures in the at least one electronic device, and the at least one electronic device may communicate diagnostic messages to the at least one server. In an embodiment of the present invention, the at least one electronic device may be portable and the network may be wireless.

In an embodiment of the present invention, the at least one server may communicate firmware updating information to the at least one electronic device, and the at least one electronic device may update the firmware using the updating information. In an embodiment of the present invention, the updating information may comprise executable instructions that convert a first firmware version to a second firmware version.

In an embodiment of the present invention, the at least one server may comprise device management software. The network may further comprise diagnostic software, which may interact with the electronic device via the device management software. The at least one electronic device may report at least one condition to the device management software, which may communicate an appropriate message to the diagnostic software. The diagnostic software may respond to a reported condition by initiating a diagnostics procedure in the at least one electronic device via the device management software. The at least one electronic device may execute the diagnostic procedure and use a diagnostic report to update the firmware.

Another aspect of the present invention may be seen in an electronic device having firmware and configuration parameters. The electronic device may comprise an agent that executes diagnostic procedures to generate a diagnostic report. The electronic device may communicate the diagnostic report to a first server and receive instructions from the first server to update the firmware and configuration parameters, based upon the diagnostic report.

The method of monitoring activities in the electronic device may comprise communicating diagnostic messages to at least one server, the electronic device being communicatively coupled to the at least one server and executing diagnostic procedures in the electronic device.

These and other features and advantages of the present invention may be appreciated from a review of the following detailed description of the present invention, along with the accompanying figures in which like reference numerals refer to like parts throughout.

### BRIEF DESCRIPTION OF SEVERAL VIEWS OF THE DRAWINGS

FIG. 1 illustrates a block diagram of an exemplary remote diagnostic network, in accordance with an embodiment of the present invention.

FIG. 2 illustrates a flow diagram of exemplary monitoring of activities in a mobile handset, in accordance with embodiment of the present invention.

FIG. 3 illustrates a block diagram of an exemplary diagnostic agent, in accordance with an embodiment of the present invention.

FIG. 4 illustrates a block diagram of an exemplary diagnostic server, in accordance with an embodiment of the present invention.

FIG. 5 illustrates a block diagram of an exemplary DM server, in accordance with an embodiment of the present invention.

### DETAILED DESCRIPTION OF THE INVENTION

The present invention relates generally to the monitoring of activities in electronic devices such as, for example, mobile handsets from a server, and specifically to the execution of diagnostic procedures in the electronic devices under the control of a diagnostic server in the carrier network. Although the following discusses aspects of the invention in terms of a mobile handset, it should be clear that the following also applies to other mobile electronic devices such as, for example, personal digital assistants (PDAs), pagers, personal computers (PCs), and similar handheld electronic devices.

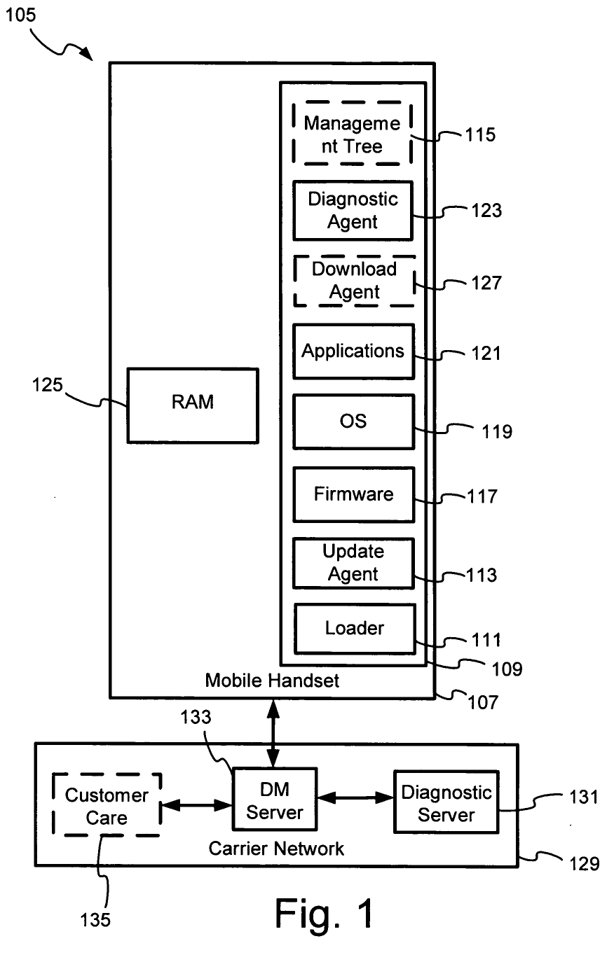

FIG. 1 illustrates a block diagram of an exemplary remote diagnostic network 105, in accordance with an embodiment of the present invention. In an embodiment of the present invention, the remote diagnostic network 105 may comprise the mobile handset 107 communicatively coupled to a carrier network 129. The carrier network 129 may comprise a device management (DM) server 133, and a diagnostic server 131. In an embodiment of the present invention, the carrier network 129 may also comprise a customer care server 135, which may be external to the carrier network 129.

The carrier network 129 may be capable of performing remote diagnostics. The carrier network 129 may be capable of handling diagnostic messages, conducting status checks, and reporting diagnostic information. The carrier network 129 may also be capable of updating firmware 117 and/or software 119, 121 in the mobile handset 107 using, for example, an update package. In an embodiment of the present invention, an update package for an electronic device such as, for example, mobile handset 107 may comprise executable instructions used to convert firmware/software in the mobile handset 107 from one version to another.

In an embodiment of the present invention, the mobile handset 107 may comprise a random access memory (RAM) unit 125 and a non-volatile memory 109. The non-volatile memory 109 may have a plurality of components such as, for example, a loader 111, an update agent 113, firmware 117, an operating system (OS) 119, applications 121, and a diagnostic agent 123. In an embodiment of the present invention, the non-volatile memory 109 may also comprise a management tree 115 and a download agent 127.

In an embodiment of the present invention, the diagnostic server 131 may interact with the mobile handset 107, via the DM server 133. For example, if the mobile handset 107 reports an error or problem to the DM server 133 or to the customer care server 135, the diagnostic server 131 may receive an appropriate message indicating the problem. In response, the diagnostic server 131 may initiate diagnostic procedures in the mobile handset 107, via the DM server 133. The execution of diagnostic procedures in the mobile handset 107 may result in the retrieval of diagnostic information, configuration parameters, etc. which may be communicated to the diagnostic server 131 by the mobile handset 107.

In an embodiment of the present invention, the diagnostic agent 123 in the mobile handset 107 may execute diagnostic procedures and may report the results to the diagnostic server 131 or the DM server 133. Interactions with the customer care server 135 related to events monitoring and diagnostic activity in the mobile handset 107 may also be facilitated by the diagnostic agent 123. The diagnostic agent 123 may facilitate the upload of diagnostics information from the mobile handset 107 to the diagnostic server 131. In an embodiment of the present invention, the diagnostic agent 123 may also utilize the download agent 127, which may facilitate the download of update packages, configuration information, etc. into the mobile handset 107. In an embodiment of the present invention, the downloaded update packages may comprise executable procedures for diagnosing the mobile handset 107.

In an embodiment of the present invention, remote diagnostics supported by the carrier network 129 may provide customer care server 135 with a snapshot of current operating conditions and a historic view of service performance of a subscriber's device such as, for example, mobile handset 107. The diagnostics solution provided by the carrier network 129 may allow a customer service representative, via the customer care server 135, to remotely test the mobile handset 107 and query the results of those tests. The customer service representative may download a cache of historical operating conditions to trace conditions leading up to a call drop in the mobile handset 107.

In an embodiment of the present invention, a carrier network 129 may be capable of conducting remote diagnostics of mobile handsets such as, for example, the mobile handset 107. The carrier network 129 may have the necessary infrastructure to determine when known problems may occur in mobile handsets 107 and determine how often these problems may occur. In an embodiment of the present invention, when a customer reports problems to a customer care representative, the carrier network 129 may track such problems, install bug fixes or remotely diagnose the problem. For example, the configuration parameters in the mobile handset 107 may be retrieved, analyzed and modified, if necessary. When the customer using the mobile handset 107 reports errors or operational problems, the carrier network 129 may be capable of verifying them or determining the nature and characteristics of such problems.

In an embodiment of the present invention, the diagnostic agent 123 may be capable of accessing and setting parameters or objects stored and maintained in a management tree 115 such as, for example, configuration parameters, provisioning information, firmware, system files, drivers, applications, software, settings, a flex file, etc., in the mobile handset 107.

In an embodiment of the present invention, remote diagnostics may provide customer care with a snapshot of current operating conditions as well as a historic view of service performance of a subscriber's mobile handset 107. A customer service representative may be able to remotely test a device and query the results of those tests. Additionally, the customer service representative may be able to download a cache of historical operating conditions to trace conditions leading up to a call drop.

In an embodiment of the present invention, the device management server 133 may provide the management component to deploy tests and queries as well as maintains a database of historical activity for each subscriber and associated mobile handset 107.

In an embodiment of the present invention, the diagnostics in the diagnostic agent 123 in the mobile handset 107 may comprise a dropped call buffer, which may record the operating environment of a period of time such as, for example, the last 20 seconds of each call and store calls flagged as “dropped.” The details for call errors may include, for example, type of failure, location, cell sites, signal strength and time. The diagnostics may comprise self-test results where the mobile handset 107 may receive a command to run a self-test of operating conditions and send the results to a console for review.

In an embodiment of the present invention, the diagnostic agent 123 in the mobile handset 107 may implement several functionalities. The diagnostic agent 123 may accept push mechanism via short message service (SMS) from the device management server 133 to trigger the diagnostic agent 123. A SMS message may contain information regarding which test to run and where to report the test results. The diagnostic agent 123 may run diagnostic tests to acquire information regarding settings such as, for example, email settings, general packet radio service (GPRS) settings, wireless application protocol (WAP) settings, multimedia message service (MMS) settings, applications installed on the mobile handset 107, OS 119 version, network roaming status, signal strength, cell tower ID and battery level. In an embodiment of the present invention, the diagnostic agent 123 may log signal strength, cell information, roaming status, battery level, and running apps every second for the last 20 seconds of a call. The log of a call flagged as “dropped” may be stored for recovery at a later date.

In an embodiment of the present invention, the diagnostic server 131 may implement several functionalities. The diagnostic server 131 may keep track of each mobile handset 107 and a history of the transactions between the diagnostic agent 123 and the diagnostic server 131. The diagnostic server 131 may provide a customer care interface to query each subscriber and mobile handset 107, which may provide subscriber, equipment, and available tests. Data from queries may be stored in a subscriber database file as well as shown in a report format on the interface for the customer service representative to use. In an embodiment of the present invention, data from queries may be stored in a database that may allow flexibility for searching data by a system console or an external management console/system. The data from any remote diagnostics query may be stored in a format such that each parameter can be searched and used for troubleshooting by other diagnostic solutions or extensions to the system.

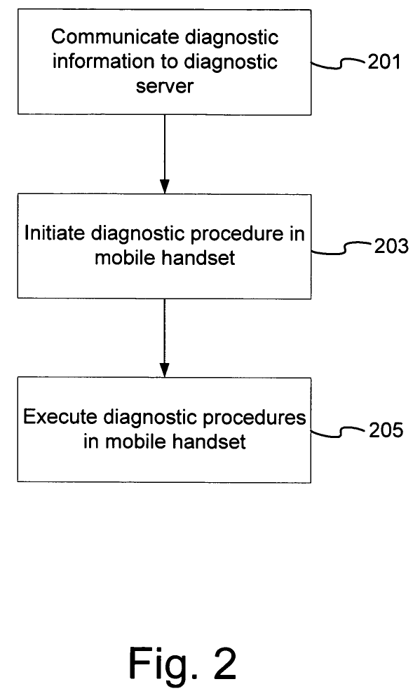

FIG. 2 illustrates a flow diagram of exemplary monitoring of activities in a mobile handset, in accordance with embodiment of the present invention. At a block 201, a mobile handset such as, for example, mobile handset 107 may communicate diagnostic information to a diagnostic server such as, for example, the diagnostic server 131. In an embodiment of the present invention, the diagnostic information may comprise conditions of the mobile handset 107 such as, for example, problems or errors detected by the hardware, software, or firmware in the mobile handset 107. The mobile handset 107 may communicate such information to the diagnostic server 131 via a device management server such as, for example, the device management server 133. At a next block 203, the diagnostic server 131 may initiate diagnostic procedures in the mobile handset 107 in response to the communicated diagnostic information. The mobile handset 107 may then execute the diagnostic procedures at a block 205. In an embodiment of the present invention, the mobile handset 107 may update the firmware based on the results of executing the diagnostic procedures.

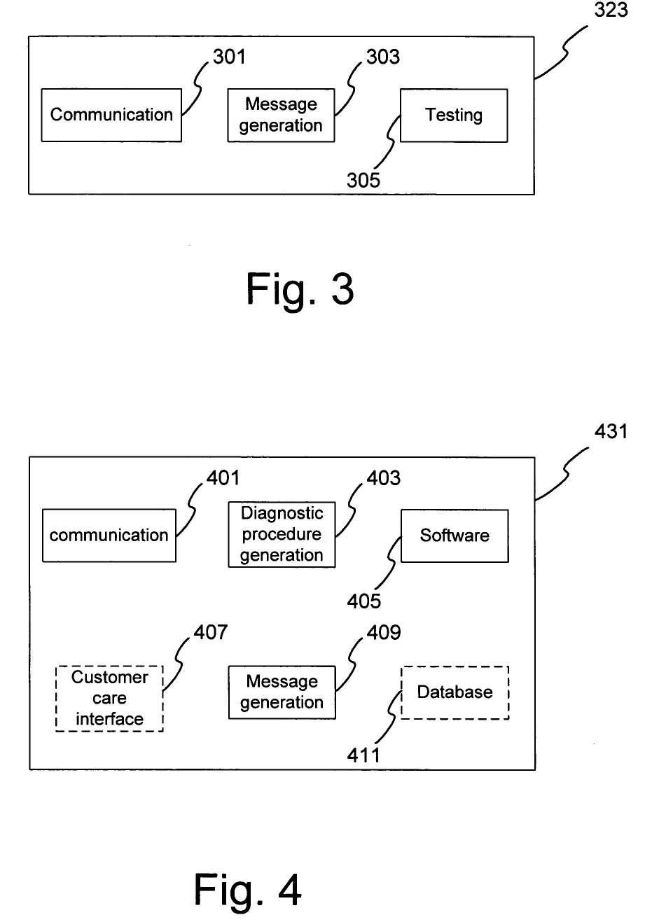

FIG. 3 illustrates a block diagram of an exemplary diagnostic agent 323, in accordance with an embodiment of the present invention. The diagnostic agent 323 may correspond, for example, to the diagnostic agent 123 of the mobile handset 107 of FIG. 1. In an embodiment of the present invention, the diagnostic agent 323 may comprise a communication block 301, a message generation block 303, and a testing block 305. The communication block 301 may communicate diagnostic messages to a diagnostic server such as, for example, the diagnostic server 131, via a DM server such as, for example, the DM server 133. The diagnostic messages may contain information regarding conditions of the mobile handset 107; such conditions may indicate problems or errors that may have occurred during such events as, for example, a phone call. The testing block 305 may facilitate diagnostics in the mobile handset 107 to determine the conditions of the mobile handset 107. The conditions may be then compiled in a format appropriate for communication to the diagnostic server 131 such as, for example, messages generated by the message generation block 303. The messages containing the conditions may be communicated to the diagnostic server 131 via the DM server 133, in response to which the diagnostic agent 323 may receive via the communication block 301, diagnostic procedures from the diagnostic server 131.

FIG. 4 illustrates a block diagram of an exemplary diagnostic server 431, in accordance with an embodiment of the present invention. The diagnostic server 431 may correspond, for example, to the diagnostic server 131 of FIG. 1. In an embodiment of the present invention, the diagnostic server 431 may comprise a communication block 401, a diagnostic procedure generation block 403, a diagnostic software block 405, and a message generation block 409. The diagnostic server 431 may also comprise a customer care interface 407, and a database 411. The diagnostic server 431 may utilize the communication block 401 to communicate messages to and from a diagnostic agent such as, for example, the diagnostic agent 323 of FIG. 3, and/or a DM server such as, for example, the DM server 133 of FIG. 1. The diagnostic server 431 may receive messages from the diagnostic agent 323 containing the results of the testing of the mobile handset 107. The diagnostic server 431 may then generate the appropriate diagnostic procedures in the diagnostic procedure generation block 403. The diagnostic procedures may be generated in a format appropriate for communication to the diagnostic agent 423 such as, for example, messages generated by the message generation block 409. The messages may contain conditions that may be communicated to the diagnostic agent 423 through the communication block 401 and the DM server 133. The software block 405 may facilitate the operations of the diagnostic server 431. In an embodiment of the present invention, the diagnostic server 431 may utilize a customer care interface, controlled by the customer care interface block 407, to query mobile handsets associated with the diagnostic server 431. The diagnostic server 431 may also utilize a database block 411, which may contain data regarding associated mobile handsets. The database may be searchable by a system console or an external management console/system.

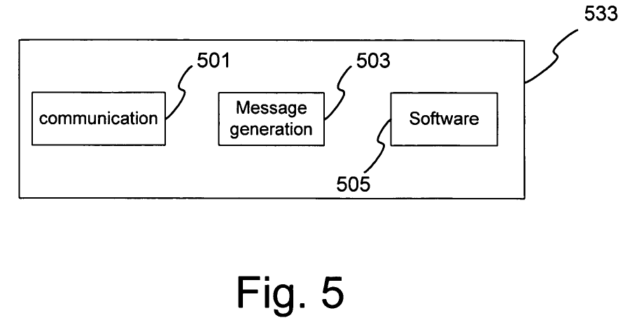

FIG. 5 illustrates a block diagram of an exemplary DM server 533, in accordance with an embodiment of the present invention. The DM server 533 may correspond, for example, to the DM server 133 of FIG. 1. In an embodiment of the present invention, the DM server 533 may comprise a communication block 501, a message generation block 503, and a software block 505. The DM server 533 may utilize the communication block 501 to communicate with a diagnostic agent such as, for example, the diagnostic agent 323 of FIG. 3, and to communicate with a diagnostic server such as, for example, the diagnostic server 431 of FIG. 4. Messages containing the conditions of the mobile handset 107 may be received by the DM server 533 from the diagnostic agent 323. The DM server 533 may then send the received messages to the diagnostic server 431. The DM server 533 may process the messages received from the diagnostic agent 323 and create messages in the message generation block 503 to send to the diagnostic server 431 along with the messages received from the diagnostic agent 323. The DM server 533 may receive message from the diagnostic server 431 containing, for example, diagnostic procedures for the mobile handset 107. The DM server 533 may communicate the messages to the diagnostic agent 323. In an embodiment of the present invention, the software block 505 may facilitate the operations of the DM server 533.

The use of an embodiment of the present invention reduces the amount of time a customer service representative spends assisting a user of a mobile handset such as, for example, the mobile handset 107 to diagnose problems in the mobile handset 107. In an embodiment of the present invention, the customer service representative may have diagnostic information available at the time a customer calls. As a result, the total time spent assisting each customer is reduced, and a larger number of customers may be assisted in the same amount of time. Additionally, customer service representatives are able to provide better assistance because of the availability of information regarding the condition of the mobile handset prior to the call from the customer. As a result, customer service time is reduced and, therefore, labor costs are reduced, leading to increased savings in operational costs, while improving the services provided to the customer.

The present invention may be realized in hardware, software, firmware and/or a combination thereof. The present invention may be realized in a centralized fashion in at least one computer system, or in a distributed fashion where different elements are spread across several interconnected computer systems. Any kind of computer system or other apparatus adapted for carrying out the methods described herein may be suitable. A typical combination of hardware and software may be a general-purpose computer system with a computer program that, when being loaded and executed, controls the computer system to carry out the methods described herein.

The present invention may also be embedded in a computer program product comprising all of the features enabling implementation of the methods described herein which when loaded in a computer system is adapted to carry out these methods. Computer program in the present context means any expression, in any language, code or notation, of a set of instructions intended to cause a system having information processing capability to perform a particular function either directly or after either or both of the following: a) conversion to another language, code or notation; and b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

1. A network that monitors activities of electronic devices in the network, the network comprising:
at least one electronic device having firmware;
at least one server communicatively coupled to the at least one electronic device, the at least one server being capable of executing diagnostic procedures in the at least one electronic device; and
wherein the at least one electronic device communicates diagnostic messages to the at least one server.

2. The network according to claim I wherein the at least one server communicates firmware updating information to the at least one electronic device.

3. The network according to claim 2 wherein the at least one electronic device updates the firmware using the updating information.

4. The network according to claim 2 wherein the updating information comprises executable instructions that convert a first firmware version to a second firmware version.

5. The network according to claim 1 wherein the at least one server comprises device management software.

6. The network according to claim 5 further comprising diagnostic software that interacts with the at least one electronic device via the device management software.

7. The network according to claim 6 wherein the at least one electronic device reports at least one condition to the device management software that communicates an appropriate message to the diagnostic software.

8. The network according to claim 7 wherein the diagnostic software responds to the at least one reported condition by initiating a diagnostics procedure in the at least one electronic device via the device management software.

9. The network according to claim 8 wherein the at least one electronic device executes the diagnostics procedure in the at least one electronic device and uses a diagnostic report to update the firmware.

10. The network according to claim 6 wherein the at least one electronic device communicates diagnostic information to the diagnostic software.

11. The network according to claim 10 wherein the at least one electronic device receives from the diagnostic software at least one instruction to update the firmware, based on a diagnosis generated by the diagnostic software.

12. The network according to claim 1 wherein the network is wireless.

13. The network according to claim 1 wherein the at least one electronic device is portable.

14. An electronic device having firmware and configuration parameters, the electronic device comprising:
an agent that executes diagnostic procedures to generate a diagnostic report;
wherein the electronic device communicates the diagnostic report to a first server to which the electronic device is communicatively coupled; and
wherein the electronic device receives instructions from the first server to update the electronic device, based upon the diagnostic report.

15. The electronic device according to claim 14 wherein the instructions received from the first server to update the electronic device comprise instructions and data that update firmware in the electronic device.

16. The electronic device according to claim 14 wherein the instructions received from the first server to update the electronic device comprise instructions and data that update a system file in the electronic device.

17. The electronic device according to claim 14 wherein the instructions received from the first server to update the electronic device comprise instructions and data that update a device driver in the electronic device.

18. The electronic device according to claim 14 wherein the instructions received from the first server to update the electronic device comprise instructions and data that update at least one of a device settings and a user account in the electronic device.

19. The electronic device according to claim 14 wherein the instructions received from the first server to update the electronic device comprise instructions and data that update at least one of firmware, system files, drivers, applications, software, settings, a configuration file and a flex file.

20. A method of monitoring activities in an electronic device with firmware, the method comprising:
communicating diagnostic messages to at least one server, the electronic device being communicatively coupled to the at least one server; and
executing diagnostic procedures in the electronic device.

21. The method according to claim 20 wherein the at least one server comprises device management software.

22. The method according to claim 21 wherein diagnostic software interacts with the electronic device via the device management software.

23. The method according to claim 22 further comprising reporting at least one condition to the device management software that communicates an appropriate message to the diagnostic software.

24. The method according to claim 23 further comprising initiating a diagnostics procedure in the electronic device in response to the at least one reported condition.

25. The method according to claim 24 further comprising:
executing the diagnostics procedure in the electronic device; and
using a diagnostic report to update the firmware.

26. The method according to claim 22 further comprising:
communicating diagnostic information to the diagnostic software;
receiving from the diagnostic software at least one instruction to update the firmware, based on a diagnosis generated by the diagnosis software.
